(19) United States
(12) Patent Application Publication
(10) Pub. No.: US 2007/0234619 A1
(43) Pub. Date: Oct. 11, 2007

(54) MEMORABILIA PRESENTATION

(75) Inventor: Brian H. Price, Innisfil (CA)

Correspondence Address: BARNES & THORNBURG LLP, P.O. BOX 2786, CHICAGO, IL, 60690-2786, US

(73) Assignee: IN THE GAME PUBLISHING L.P., Markham (CA)

(21) Appl. No.: 11/674,575

(22) Filed: Feb. 13, 2007

Related U.S. Application Data
(60) Provisional application No. 60/743,291, filed on Feb. 14, 2006.

(51) Int. Cl. G09F 3/20

(52) U.S. Cl. 40/654.01

(57) ABSTRACT

a book for presenting a group of memorabilia items relating to a series of linked events and/or circumstances, includes a plurality of page panels, the page panels providing a number of page panel faces organized in pairs, each pair presenting a left hand page panel face and a right hand page panel face; a first of the pairs relating to a first event and/or circumstance, the first pair including a first right hand page panel face and a first left hand page panel face, either one or both including indicia representative of graphics and/or text descriptive of the first event or circumstance and the other including a first memorabilia receiving region to receive a first memorabilia item pertinent to the first event and/or circumstance; and the first memorabilia item positioned in the first memorabilia receiving region; a second of the pairs relating to a second event and/or circumstance which is linked with the first event and/or circumstance by a predetermined value, the second pair including a second right hand page panel face and a second left hand page panel face, either one or both including indicia representative of graphics and/or text descriptive of the second event and/or circumstance and the other including a second memorabilia receiving region to receive a second memorabilia item pertinent to the second event and/or circumstance; and the second memorabilia item positioned in the second memorabilia receiving region.

### CROSS-REFERENCE TO RELATED APPLICATIONS

The entire subject matter of U.S. Provisional application Ser. No. 60/743,291, filed Feb. 14, 2006, and entitled MEMORABILIA PRESENTATION, is incorporated by reference. The applicants claim priority benefit under Title 35, United States Code, Section 119 of U.S. Provisional application Ser. No. 60/743,291 filed Feb. 14, 2006 and entitled MEMORABILIA PRESENTATION.

### BACKGROUND OF THE INVENTION

1. Field of the Invention

The present invention relates to memorabilia, for example sports memorabilia.

2. Description of the Related Art

The collecting of memorabilia, such as sports memorabilia, is becoming more popular, especially with the aging baby boomer generation. Memorabilia are often presented as trophies. Baseballs, for instance, are now being presented in a transparent hollow globe on a pedestal. Baseball cards, the most ubiquitous of all sports memorabilia, are now held in a vast array of albums, plastic carrying cases and the like.

### SUMMARY OF THE INVENTION

In one aspect, there is provided a book for presenting a group of memorabilia items relating to a series of linked events and/or circumstances, comprising: a plurality of page panels, the page panels providing a number of page panel faces organized in pairs, each pair presenting a left hand page panel face and a right hand page panel face; a first of the pairs relating to a first event and/or circumstance, the first pair including a first right hand page panel face and a first left hand page panel face, either one or both including indicia representative of graphics and/or text descriptive of the first event or circumstance and the other including a first memorabilia receiving region to receive a first memorabilia item pertinent to the first event and/or circumstance; and the first memorabilia item positioned in the first memorabilia receiving region; a second of the pairs relating to a second event and/or circumstance which is linked with the first event and/or circumstance by a predetermined value, the second pair including a second right hand page panel face and a second left hand page panel face, either one or both including indicia representative of graphics and/or text descriptive of the second event and/or circumstance and the other including a second memorabilia receiving region to receive a second memorabilia item pertinent to the second event and/or circumstance; and the second memorabilia item positioned in the second memorabilia receiving region.

In an alternative embodiment, the first right hand page panel face and the second left hand page panel face are located on opposite sides of a single page panel.

An alternative embodiment further comprises a binder portion, the plurality of page panels being removably bound with the binder portion.

In an alternative embodiment, the binder portion includes a plurality of ring portions, each movable between a substantially continuous closed position and an open position.

In an alternative embodiment, the number of page panel faces includes a third pair having a third right hand page panel face and a third left hand page panel face, either one or both including indicia representative of graphics and/or text descriptive of a third event and/or circumstance and the other including a third memorabilia receiving region to receive a third memorabilia item pertinent to the third event and/or circumstance; the third right hand page panel face being provided on a first intermediate page panel, the first intermediate page panel including an index left hand page panel face including indicia representative of graphics and/or text descriptive of a first version of an index for the book.

An alternative embodiment further comprises a pair of second intermediate page panels to replace the first intermediate page panel and to provide the third right hand page panel face and to provide a fourth pair of page panel faces for a fourth event and/or circumstance, either one of the fourth page panel faces including indicia representative of graphics and/or text descriptive of the fourth event and/or circumstance and the other including a fourth memorabilia receiving region to receive a fourth memorabilia item pertinent to the fourth event and/or circumstance, one of the second intermediate page panels including an index page panel face whose indicia are representative of graphics and/or text descriptive of a second version of the index for the book and including the fourth event and/or circumstance.

In an alternative embodiment, the event and/or circumstance is a sports event and/or circumstance being selected from professional and/or non-professional sports events or circumstances.

In an alternative embodiment, the sports events and/or circumstances include one or games, events, circumstances or matches in one or more seasons and/or for one or more teams and/or for one or more athletes.

In an alternative embodiment, the sports events and/or circumstances includes one or more games of hockey, baseball, basketball, football, automobile racing and/or soccer.

In an alternative embodiment, the sports events and/or circumstances include one or more Olympic games or events and/or circumstances.

In an alternative embodiment, the first and/or second memorabilia item includes a portion of a game element, an item of game equipment, a race car or race vehicle or a portion of an item related directly or indirectly with a game element, an item of game equipment, a race car or race vehicle, or a personal article of, or an article related directly or indirectly to, a celebrated individual associated with the corresponding sports event and/or circumstance.

In an alternative embodiment, the indicia are representative of biographical information relating to the celebrated individual.

In an alternative embodiment, the indicia are representative of an image of the celebrated individual.

In another aspect, there is provided a method of selling a memorabilia book presenting a group of memorabilia items relating to a series of linked events and/or circumstances, comprising: providing a binder portion and a plurality of page panels to be removably mounted in the binder portion; providing on the plurality of page panels, a number of page panel faces organized in pairs, each pair presenting a left hand page panel face and a right hand page panel face; configuring a first of the pairs to relate to a first event and/or circumstance, with the first pair including a first right hand page panel face and a first left hand page panel face, with either one including indicia representative of graphics and/or text descriptive of the first event and/or circumstance and the other including a first memorabilia receiving region to receive a first memorabilia item pertinent to the first event and/or circumstance; and locating the first memorabilia item in the first memorabilia receiving region; configuring a second of the pairs to relate to a second event and/or circumstance which is associated with the first event and/or circumstance by a predetermined correspondence, with the second pair including a second right hand page panel face and a second left hand page panel face, with either one including indicia representative of graphics and/or text descriptive of the second event and/or circumstance and the other including a second memorabilia receiving region to receive a second memorabilia item pertinent to the second event and/or circumstance; and locating the second memorabilia item in the second memorabilia receiving region; assembling sale packages including one or more binder portions and a set of page panels for each binder portion; collecting one or more orders for sale packages from one or more buyers; accepting one or more payments for the sale packages from the one or more buyers; and dispatching the sale packages to the one or more buyers.

An alternative embodiment further comprises providing the first right hand page panel face and the second left hand page panel face on opposite sides of a single page panel.

An alternative embodiment further comprises providing the binder portion with a plurality of ring portions, configuring the rings to be movable between a substantially continuous closed position and an open position to extend through corresponding openings in the page panels.

An alternative embodiment further comprises: providing the number of page panel faces with a third pair including a third right hand page panel face and a third left hand page panel face, with either one including indicia representative of graphics and/or text descriptive of a third event and/or circumstance and the other including a third memorabilia receiving region to receive a third memorabilia item pertinent to the third event and/or circumstance; locating the third memorabilia item in the third memorabilia receiving region; providing the third right hand page panel face on a first intermediate page panel; providing the first intermediate page panel with an index left hand page panel face including indicia representative of graphics and/or text descriptive of a first version of an index for the book.

An alternative embodiment further comprises comprising offering the one or more buyers a subscription program to update the book.

An alternative embodiment further comprises providing a pair of second intermediate page panels to replace the first intermediate page panel and to provide a fourth pair of page panel faces for a fourth event and/or circumstance, with either one of the fourth page panel faces including indicia representative of graphics and/or text descriptive of the fourth event and/or circumstance and the other including a fourth memorabilia receiving region to receive a fourth memorabilia item pertinent to the fourth event and/or circumstance, one of the second intermediate page panels including a left hand index page panel face whose indicia is representative of graphics and/or text descriptive of a second version of the index for the book and including the fourth event and/or circumstance.

An alternative embodiment further comprises: offering a subscription program to the one or more buyers; assembling subscription program packages including one or more sets of second intermediate page panels; collecting one or more orders for subscription program packages for one or more buyers; accepting one or more payments for the subscription program packages from the one or more buyers; and dispatching the subscription program packages to the one or more buyers.

In another aspect, there is provided a book for presenting a group of memorabilia items relating to a series of linked events and/or circumstances, comprising: a plurality of page panels organized in pairs, with each pair presenting a left hand page panel face and a right hand page panel face; a first of the pairs having a first right hand page panel face and a first left hand page panel face, either one of the page panel faces in the first pair including indicia representative of graphics and/or text descriptive of a first event and/or circumstance; the other of the page panel faces in the first pair including a first memorabilia receiving region to receive a first memorabilia item pertinent to the first event and/or circumstance; and the first memorabilia item positioned in the first memorabilia receiving region; a second of the pairs having a second right hand page panel face and a second left hand page panel face, either one of the page panel faces in the second pair including indicia representative of graphics and/or text descriptive of a second event and/or circumstance; the other page panel face in the second pair including a second memorabilia receiving region to receive a second memorabilia item pertinent to the second event and/or circumstance; and the second memorabilia item circumstance positioned in the second memorabilia receiving region.

In an alternative embodiment, the number of page panel faces includes a third pair of page panel faces, the third pair including a third right hand page panel face and a third left hand page panel face, either one of the third page panel faces including indicia representative of graphics and/or text descriptive of a third event and/or circumstance, the other of the third page panel faces including a third memorabilia receiving region to receive a third memorabilia item pertinent to the third event and/or circumstance; the third right hand page panel face being provided on a first intermediate page panel, the first intermediate page panel including an index left hand page panel face including indicia representative of graphics and/or text descriptive of an index for the book.

An alternative embodiment further comprises a pair of second intermediate page panels to replace the first intermediate page panel and to provide a fourth pair of page panel faces for a fourth event and/or circumstance, either one of the fourth page panel faces including indicia representative of graphics and/or text descriptive of the fourth event and/or circumstance, the other of the fourth page panel faces including a fourth memorabilia receiving region to receive a fourth memorabilia item pertinent to the fourth event and/or circumstance, one of the second intermediate page panels including an index page panel face whose indicia is representative of graphics and/or text descriptive of an index for the book, including the fourth event and/or circumstance.

In another aspect, there is provided a portfolio for presenting a group of memorabilia items relating to a series of linked events and/or circumstances, comprising: a plurality of page panels, the page panels providing a number of page panel faces organized in groups, each group presenting a first page panel face and a second page panel face; a first of the groups relating to a first event and/or circumstance, one of the faces of the first group including indicia representative of graphics and/or text descriptive of the first event or circumstance and another of the faces of the first group including a first memorabilia receiving region to receive a first memorabilia item pertinent to the first event and/or circumstance; and the first memorabilia item positioned in the first memorabilia receiving region; a second of the groups relating to a second event and/or circumstance which is related with the first event and/or circumstance by a predetermined value, one of the faces of the second group including indicia representative of graphics and/or text descriptive of the second event and/or circumstance and another of the faces of the second group including a second memorabilia receiving region to receive a second memorabilia item pertinent to the second event and/or circumstance; and the second memorabilia item positioned in the second memorabilia receiving region.

In another aspect, there is provided a reference assembly for presenting a group of memorabilia items relating to a series of linked events and/or circumstances, comprising: a plurality of page panels, the page panels providing a number of page panel faces organized in pairs, each pair presenting an upper page panel face and a lower page panel face, relative to a horizontal axis; a first of the pairs relating to a first event and/or circumstance, the first pair including a first upper page panel face and a first lower page panel face, either one including indicia representative of graphics and/or text descriptive of the first event or circumstance and the other including a first memorabilia receiving region to receive a first memorabilia item pertinent to the first event and/or circumstance; and the first memorabilia item positioned in the first memorabilia receiving region; a second of the pairs relating to a second event and/or circumstance which is linked with the first event and/or circumstance by a predetermined value, the second pair including a second upper page panel face and a second lower page panel face, either one including indicia representative of graphics and/or text descriptive of the second event and/or circumstance and the other including a second memorabilia receiving region to receive a second memorabilia item pertinent to the second event and/or circumstance; and the second memorabilia item positioned in the second memorabilia receiving region.

In another aspect, there is provided a method of selling a sports memorabilia book presenting a group of sports memorabilia items relating to a series of linked sports events and/or circumstances, comprising: providing a binder portion and a plurality of page panels to be removably mounted in the binder portion; providing on the plurality of page panels, a number of page panel faces organized in pairs, each pair presenting a left hand page panel face and a right hand page panel face; configuring a first of the pairs to relate to a first sports event and/or circumstance, with the first pair including a first right hand page panel face and a first left hand page panel face, with either one including indicia representative of graphics and/or text descriptive of the first sports event and/or circumstance and the other including a first memorabilia receiving region to receive a first memorabilia item pertinent to the first sports event and/or circumstance; and locating the first memorabilia item in the first memorabilia receiving region; configuring a second of the pairs to relate to a second sports event and/or circumstance which is associated with the first sports event and/or circumstance by a predetermined correspondence, with the second pair including a second right hand page panel face and a second left hand page panel face, with either one including indicia representative of graphics and/or text descriptive of the second sports event and/or circumstance and the other including a second memorabilia receiving region to receive a second memorabilia item pertinent to the second sports event and/or circumstance; and locating the second memorabilia item in the second memorabilia receiving region; assembling sale packages including one or more binder portions and a set of page panels for each binder portion; collecting one or more orders for sale packages from one or more buyers; accepting one or more payments for the sale packages from the one or more buyers; and dispatching the sale packages to the one or more buyers.

In another aspect, there is provided a method of selling a memorabilia book presenting a group of memorabilia items relating to a series of linked events and/or circumstances, comprising: a step for providing a binder portion and a plurality of page panels to be removably mounted in the binder portion; a step for providing on the plurality of page panels, a number of page panel faces organized in pairs, each pair presenting a left hand page panel face and a right hand page panel face; a step for configuring a first of the pairs to relate to a first event and/or circumstance, with the first pair including a first right hand page panel face and a first left hand page panel face, with either one including indicia representative of graphics and/or text descriptive of the first event and/or circumstance and the other including a first memorabilia receiving region to receive a first memorabilia item pertinent to the first event and/or circumstance; and a step for locating the first memorabilia item in the first memorabilia receiving region; a step for configuring a second of the pairs to relate to a second event and/or circumstance which is associated with the first event and/or circumstance by a predetermined correspondence, with the second pair including a second right hand page panel face and a second left hand page panel face, with either one including indicia representative of graphics and/or text descriptive of the second event and/or circumstance and the other including a second memorabilia receiving region to receive a second memorabilia item pertinent to the second event and/or circumstance; and a step for locating the second memorabilia item in the second memorabilia receiving region; a step for assembling sale packages including one or more binder portions and a set of page panels for each binder portion; a step for collecting one or more orders for sale packages from one or more buyers; a step for accepting one or more payments for the sale packages from the one or more buyers; and a step for dispatching the sale packages to the one or more buyers.

In another aspect, there is provided a book for presenting a group of memorabilia items relating to a series of linked events and/or circumstances, comprising: a plurality of page means, the page means providing a number of faces organized in pairs, each pair presenting a left hand face and a right hand face; a first of the pairs relating to a first event and/or circumstance, the first pair including a first right hand face and a first left hand face, either one or both including indicia representative of graphics and/or text descriptive of the first event or circumstance and the other including a first memorabilia receiving means to receive a first memorabilia item pertinent to the first event and/or circumstance; and the first memorabilia item positioned in the first memorabilia receiving means; a second of the pairs relating to a second event and/or circumstance which is linked with the first event and/or circumstance by a predetermined value, the second pair including a second right hand face and a second left hand face, either one or both including indicia representative of graphics and/or text descriptive of the second event and/or circumstance and the other including a second memorabilia receiving means to receive a second memorabilia item pertinent to the second event and/or circumstance; and the second memorabilia item positioned in the second memorabilia receiving means.

### BRIEF DESCRIPTION OF THE DRAWINGS

Several preferred embodiments of the present invention will now be described, by way of example only, with reference to the appended drawings in which:

FIG. 1 is a perspective view of a memorabilia presentation in the form of a book;

FIG. 2 is a perspective view of the book of FIG. 1 in an open orientation

FIG. 3 is another perspective view of the book of FIG. 1 in the orientation of FIG. 2;

FIG. 3a is a sectional view taken along line 3a-3a of FIG. 3 of the book in one orientation;

FIG. 3b is another section view according to FIG. 3a of the book in another orientation;

FIG. 4 is a perspective view of the book of FIG. 1 in yet another open orientation; FIG. 5 is a perspective view of another memorabilia book;

FIG. 5a is a sectional view taken along line 5a-5a of FIG. 5;

FIG. 6 is a perspective view of the book of FIG. 5 in another configuration;

FIGS. 7, 8 and 9 are perspective views of the book of FIG. 5 in other configurations;

FIGS. 10 and 11 are perspective views of yet other memorabilia books;

FIG. 12 is a perspective part-sectional view of another version of the book of FIG. 1;

FIG. 13 is a perspective part-sectional view of another version of the book of FIG. 5;

FIGS. 14 and 15 are perspective views of other books; and

FIGS. 16 and 17 are plan views of still further alternative books.

### DESCRIPTION OF THE PREFERRED EMBODIMENTS

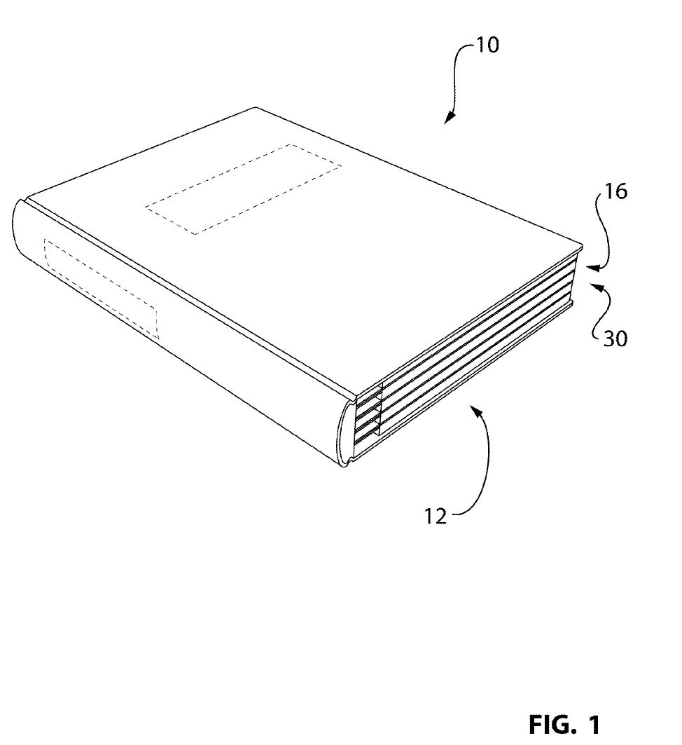

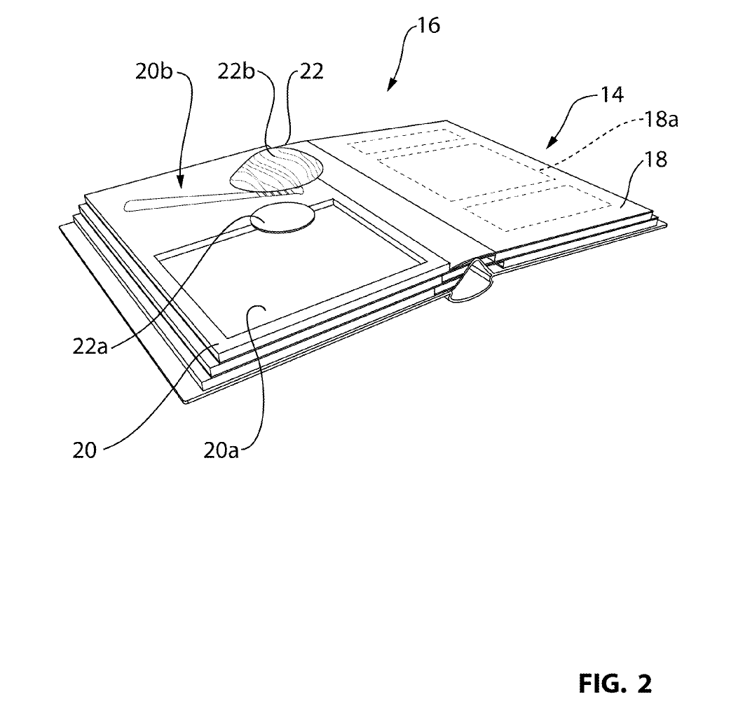

Referring to FIGS. 1 and 2, there is provided a memorabilia presentation in the form of a book 10 for presenting a group of memorabilia items relating to a series of linked events or circumstances, such as sports events or sports history. The book has a plurality of page panels 12 which provide a number of page panel faces shown generally at 14 and organized in groups of odd or even numbers of page faces, in this case pairs. As will be described, for this example, each pair presents a left hand page panel face and a right hand page panel face.

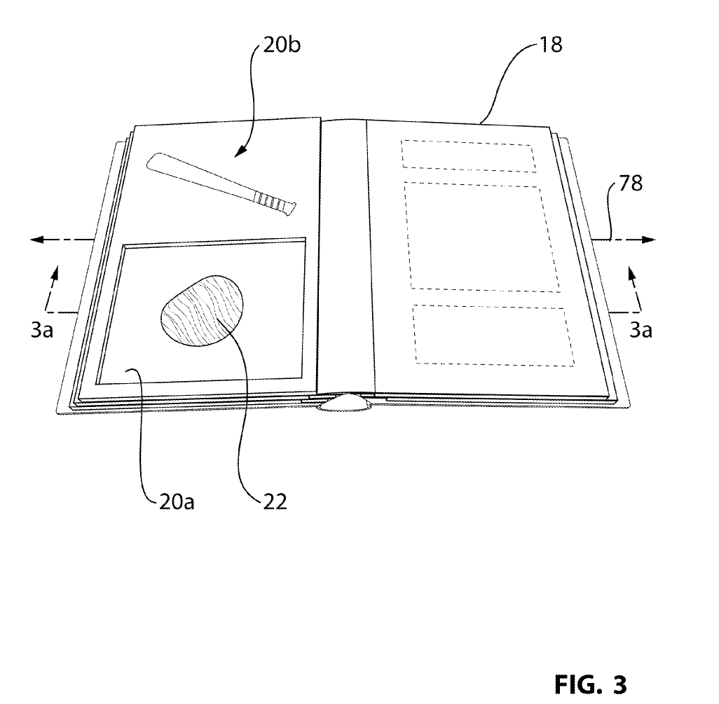

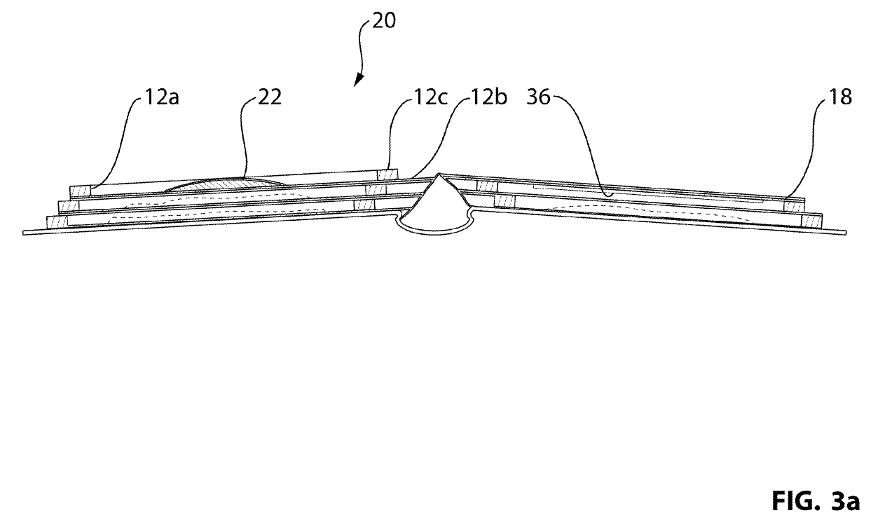

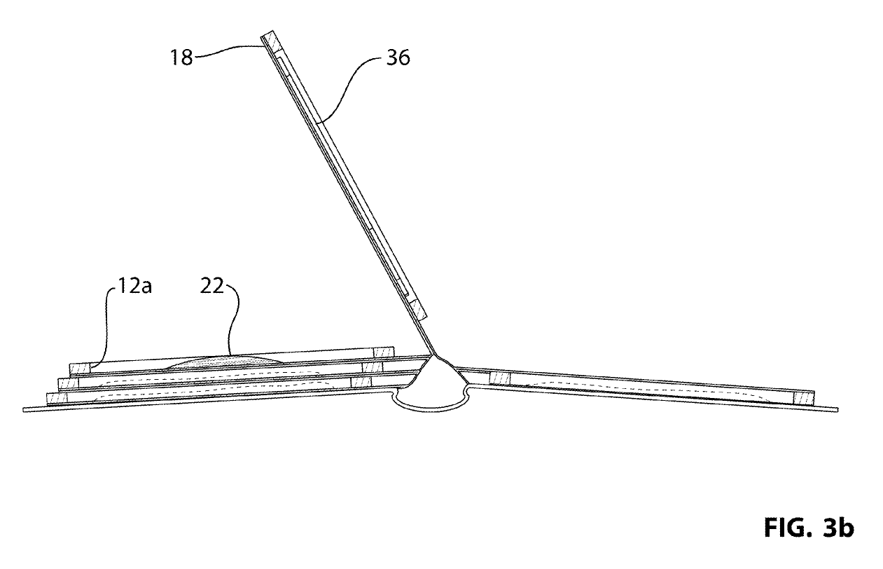

A first of the pairs is shown generally at 16 and relates to a first event or circumstance and includes a first right hand page panel face 18 and a first left hand page panel face 20. Either panel face (in this case the right hand page panel face 18) includes indicia shown generally at 18a and representative of graphics and/or text descriptive of the first event or circumstance while the other (in this case the left hand page panel face 20) includes a first memorabilia receiving region 20a to receive a first memorabilia item 22 pertinent to the first event or circumstance. The first memorabilia item 22 can thus be seen positioned in the first memorabilia receiving region 20a in FIG. 3.

It will be seen in FIG. 2 that the first pair 16 is not, in this example, physically located on the first and second page panels of the book but may occur somewhere within the book. For instance, this arrangement contemplates examples where the book 10 may have a number of earlier pages, ahead of those containing the first of the pairs 16, wherein these earlier pages simply contain indicia without a memorabilia receiving region or zone. On the other hand, the first pair 16 may be located at the beginning of the book, or somewhere else within the book, as desired.

Referring to FIG. 3a, each page panel, in this example, is constructed of one or more plastic, paper, cardboard and/or other materials (in this example in substrate form) and suitable to provide a thickness ranging from about 1/16 to about ½ inch to permit the book to accommodate memorabilia items which have a significant profile off the page panel face. The page panel 12 presenting the page panel face 20 is constructed to provide the first memorabilia receiving region 20a as a cut-out or punch-out window 12a. This can be constructed by several layers of panel forming materials, including one or more than one first (in this case lower) panel 12b and one or more than one second (in this case upper) panel 12c, with the upper panel 12c providing window 12a. For instance, other configurations are contemplated including those in which the page panels do not fall within the thickness range mentioned above. For instance, the page panels 12 may be of a conventional paper thickness to accommodate memorabilia items such as fabric, paper and the like that present a minimal outer profile off the page panel face. Still further, the panels 12 may be of varying dimensions to accommodate the memorabilia item being presented thereon. For instance, a page presenting a fabric item may be located alongside an adjacent page panel of considerable thickness to accommodate a memorabilia item of wood, rubber, glass, plastic or other material construction. In one example, a first fabric, wood or plastic sample may be relatively thin and the second panel 12c in a panel 12 to accommodate this thin first sample may be correspondingly relatively thin. In another example, a second sample may be relatively thick and the second panel 12c in a panel 12 to accommodate this second thick second sample may be correspondingly relatively thick. In the case of the book 10 as presented in FIGS. 3a and 3b, the second page panels 12c are generally the same size to accommodate the second memorabilia item 22 and another as will be described, as well as others shown generally in dashed lines. Furthermore, pages containing memorabilia items may be interspersed in a number of pages which do not present a memorabilia item according to a regular or irregular pattern, depending on the subject of the book.

In this case, the memorabilia item 22 is a sample portion of a baseball bat which has an inner flat or otherwise suitably prepared surface for securing to the first memorabilia receiving region 20a, for example by way of an adhesive layer shown at 22a (FIG. 2). The first memorabilia item 22 also has an outer surface 22b which is randomly profiled in a manner that will depend on what section of the bat the sample portion was taken. For instance, if the sample portion is taken from a handle end of the bat, the outer surface may have a smaller profile relatively less pronounced and a sample portion taken from the ball contact end of the bat may have a larger more pronounced profile.

In this case, the first left hand page panel face 20 is also provided with indicia 20b which in this particular example include a graphic representation of the baseball bat from which the first memorabilia item 22 originated, but may be representative of other graphic and/or text relative to the subject memorabilia item.

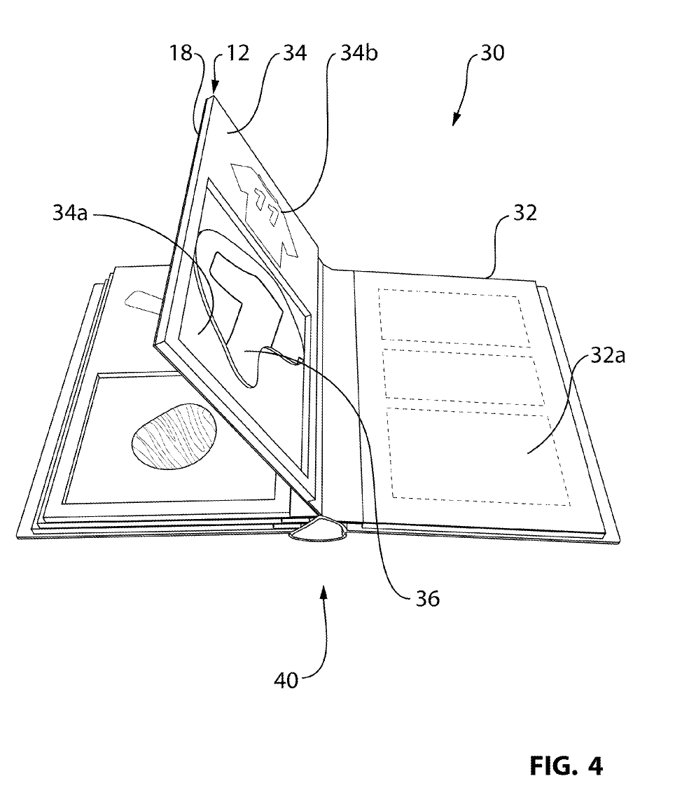

Referring to FIG. 4, the second of the pairs is shown generally at 30 in FIGS. 1 and 4 and relates to a second sports event or circumstance which is linked, related or otherwise associated with the first event or circumstance, for example by a predetermined value and/or correspondence. For example, the sports events or circumstances may be selected from professional and/or non-professional sports events or circumstances, such as team sports events or histories. The sports events or circumstances may include one or games, events, circumstances or matches in one or more seasons and/or for one or more teams and/or for one or more athletes. Among many not named here, the sports events or circumstances may include one or more games of hockey, baseball, basketball, football, golf, lacrosse, croquet, skittles, snooker and/or soccer and the like. The sports events or circumstances may include one or more Olympic Games or events and the like.

The second pair 30 thus includes a second right hand page panel face 32 and a second left hand page panel face 34. Again, either panel face, (in this case the second right hand page panel face 32) includes indicia 32a representative of graphics and/or text descriptive of the second event or circumstance and the other (in this case the left hand page panel face 34) includes a second memorabilia receiving region 34a to receive a second memorabilia item 36 pertinent to the second event or circumstance. The second memorabilia item 36 is thus positioned in the second memorabilia receiving region 34a.

In this case, the second memorabilia item 36 is a portion of a sports jersey, for example worn by a particular celebrated individual relating to the second event or circumstance. As with the first left hand page panel face 20, the second left hand page panel face 34 is provided with indicia 34b which are graphic representations of the jersey from which the second memorabilia item originated, though the indicia 34b is not necessary in all cases. There may be some examples in which the indicia 34b are omitted.

Thus, the first and/or second memorabilia item may include a portion of a game element, an item of game equipment or a personal article of a celebrated individual associated with the corresponding sports event or circumstance. Among a number of other possibilities, the indicia may be representative of biographical information relating to the celebrated individual, or representative of an image of the celebrated individual. The indicia may also include photographs, drawings, sketches and/or renderings of the celebrated individual, as desired.

In the example of FIG. 4, the first right hand page panel face 18 and the second left hand page panel face 34 are located on opposite sides of a single page panel 12. The pages 12 are bound in a binder portion 40. In this case, the pages 12 may be permanently bound or removably bound with the binder portion 40.

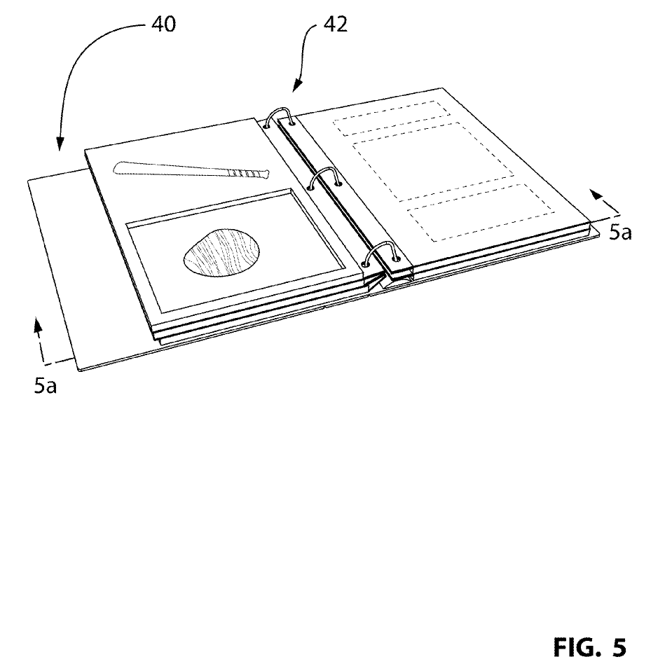

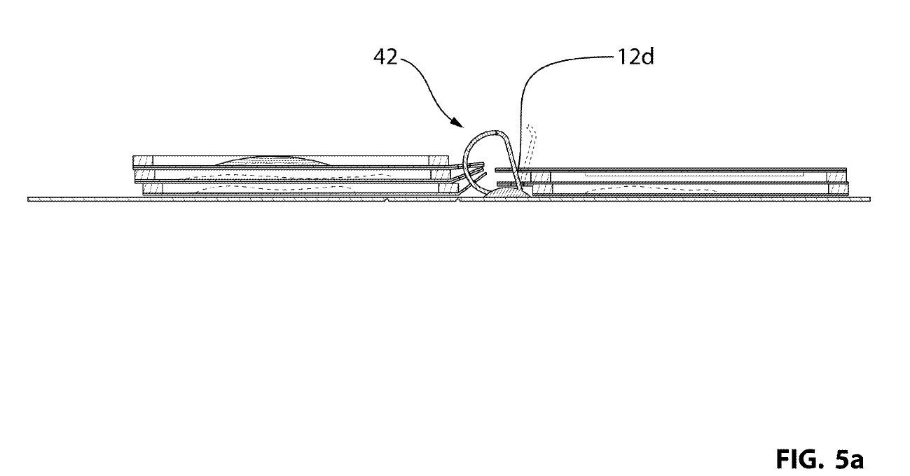

Another book is shown in FIGS. 5 and 5a, wherein the binder portion 40 includes a plurality of ring portions 42, each of which is to be movable between a substantially continuous closed position and an open position and, in the latter position, to extend through corresponding openings 12d in the page panels 12 when being inserted therein.

Referring to FIG. 6, the number of page panel faces includes a third pair 50 including a third right hand page panel face 52 and a third left hand page panel face 54. As before, either one (in this case the third right hand page panel face 52) includes indicia representative of graphics and/or text descriptive of a third event or circumstance and the other (in this case the third left hand page panel face 54) includes a third memorabilia receiving region 54a to receive a third memorabilia item 56 pertinent to the third event or circumstance.

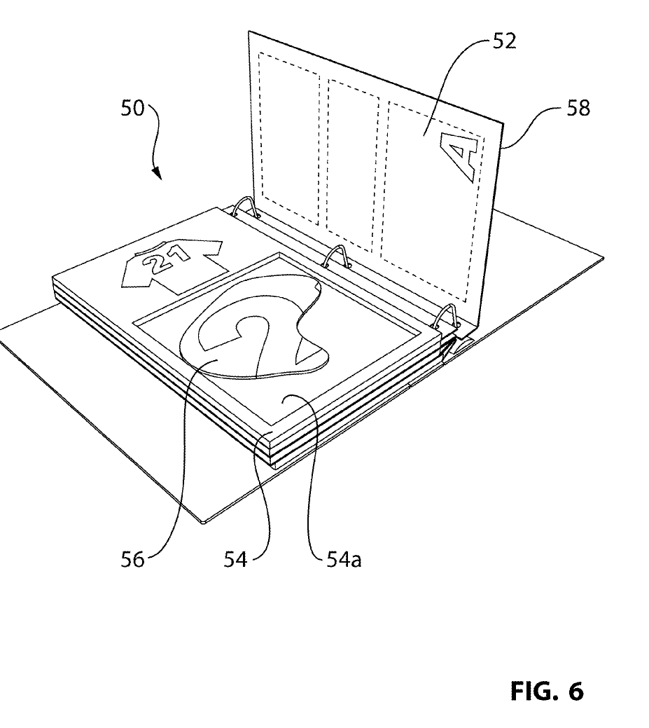

In this case, the third right hand page panel face 52 is provided on a first intermediate page panel 58. The first intermediate page panel includes an index left hand page panel face 60 (FIG. 7) including indicia representative of graphics and/or text descriptive of a first version of an index for the book.

For example, the book may be suited to a subscription program, allowing the user of the book to update the book as sports or other relevant, related or associated events or circumstances change and the personalities in the relevant sport and their careers develop and widen. The subscription program and/or the book may also be adapted to other areas as mentioned above and beyond the realm of sports. As in one illustrative example of many possibilities, the subscription program may involve the evolving career track of several members in a famous high school physics class in which the students have become famous. Alternatively, the subscription program may be for a particular period in history, such as a particular battle, in which memorabilia from the battle become available over a regular subscription term. The events or circumstances may include rock groups, jazz legends, chess players, legal practitioners, politicians and others.

The events or circumstances may include auto sports, including automobile racing, including those identified by the trade names NASCAR, CART and FORMULA 1. In this case, the article may include parts or fragments of vehicles involved in famous races, famous crashes, or vehicles owned by legendary race car drivers, or items of clothing, accessories, promotions or assorted paraphernalia, including articles or items indirectly or directly related to the sport of automobile racing or the people involved with it, such as Paul Newman, in which case the book may include movie, auto racing and, for that matter, salad making memorabilia articles or items or fragments thereof. The events or circumstances may be intermingled throughout the book so that, one page may involve an event such as the hockey game in which Jacques Plante was injured while another page pair may be concerned with the mask itself.

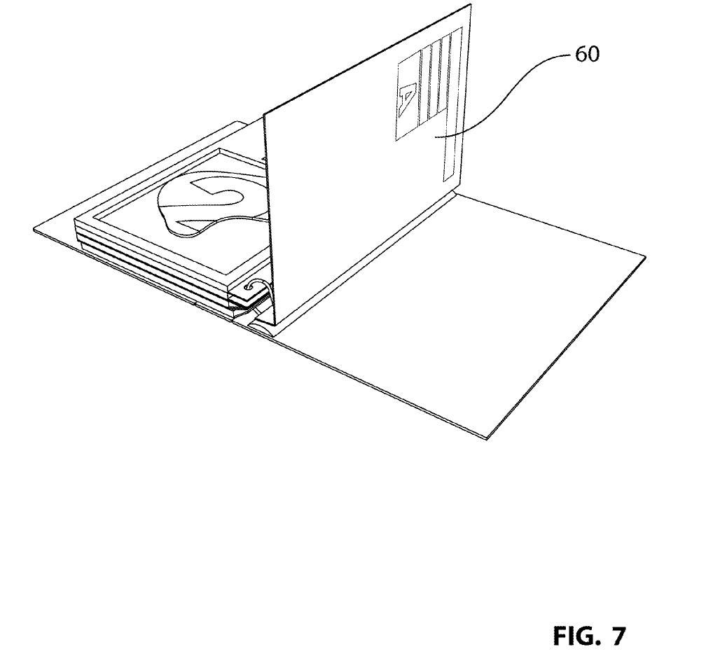

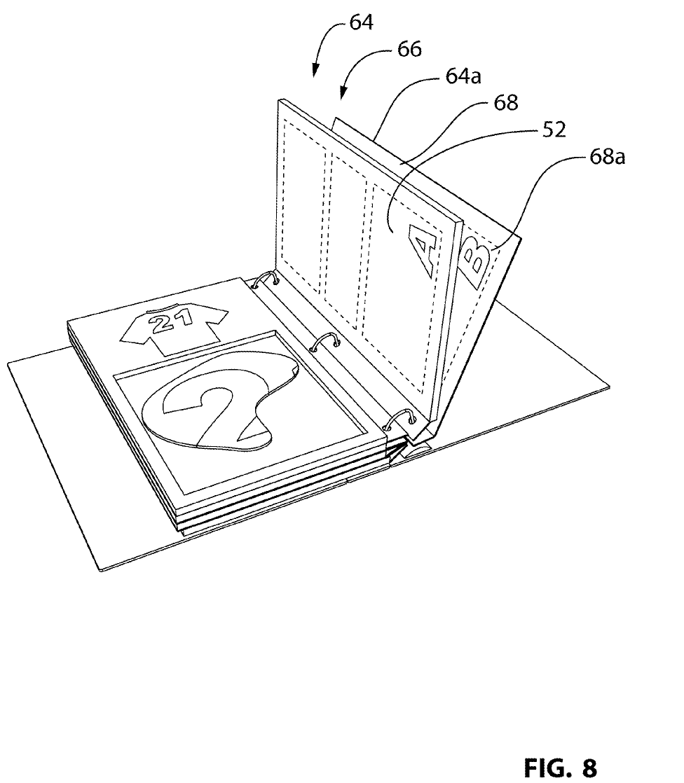

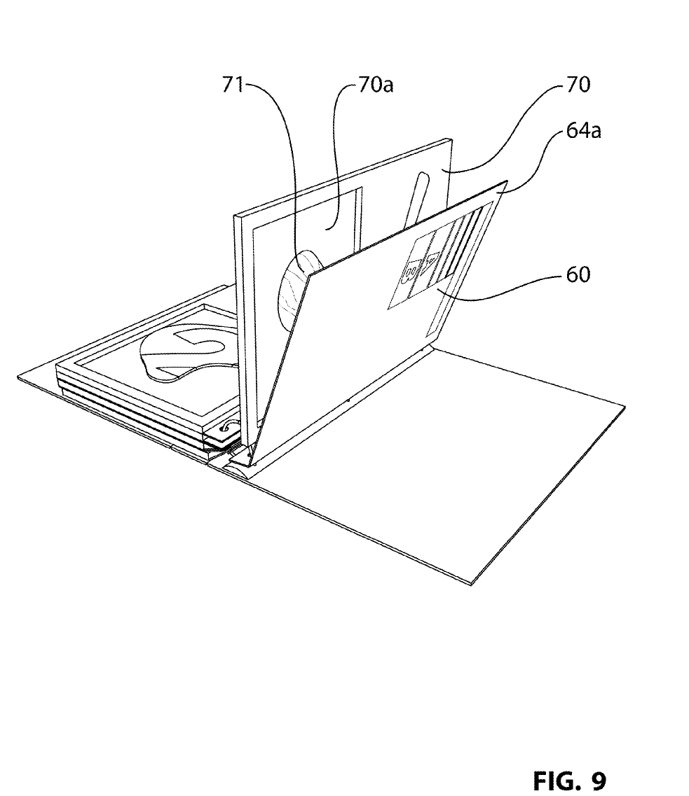

Referring to FIG. 8, the book may be provided with a pair of second intermediate page panels 64 to replace the first intermediate page panel 58 of FIG. 6. The second intermediate page panels 64, in this example, provide the third right hand page panel face 52 as well as a fourth pair of page panel faces for a fourth event or circumstance. Either one (in this case the fourth right hand page panel face 68) includes indicia 68a representative of graphics and/or text descriptive of the fourth event or circumstance and the other (in this case the fourth left hand page panel face 70 in FIG. 9) includes a fourth memorabilia receiving region 70a to receive a fourth memorabilia item 71 pertinent to the fourth event or circumstance. One of the second intermediate page panels (in this case the right hand second intermediate page panel 64a) includes the index page panel face 60 whose indicia is representative of graphics and/or text descriptive of a second version of the index for the book and including the fourth event or circumstance.

Thus, the book has features that lend itself to be part of a subscription sales program. In addition to preparing the binder portion and page panels as above discussed, the method includes assembling sale packages including one or more portions and a set of page panels 12 for each binder portion 40.

The subscription may be offered in a number of methods including direct mail, phone solicitation, retail store front, internet or the like. The method may include providing an ecommerce website. The method includes collecting one or more orders for sale packages from one or more customers or buyers and accepting one or more payments for the sale packages from the one or more buyers and then dispatching the sale packages to the one or more buyers. Thus, the book may be offered in binder form in which the binder is first purchased by a customer with a first collection of pages with a relatively small collection of memorabilia items and related graphics and/or text explaining them. The binder may have an index page and/or a table of contents page or pages or groups of pages or tabbed pages to aid the customer in accessing a particular pair of page panel faces relating to a particular memorabilia item. The customer may then be offered regular or irregular or periodic updates to the binder including additional pages providing additional memorabilia items and graphics and/or text explaining them. The updates may thus include replacement index and/or table of contents and/or tabbed pages or the like as the case may be to reflect the additional pages.

Thus, the binder may be sold by offering a subscription program to the one or more buyers. In one example, subscription program packages are assembled including one or more sets of second intermediate page panels. One or more orders are collected for subscription program packages for one or more buyers. One or more payments are then accepted for the subscription program packages from the one or more buyers. Subscription program packages may then be dispatched to the one or more buyers using alternative delivery routes such as ground or air mail, courier and the like.

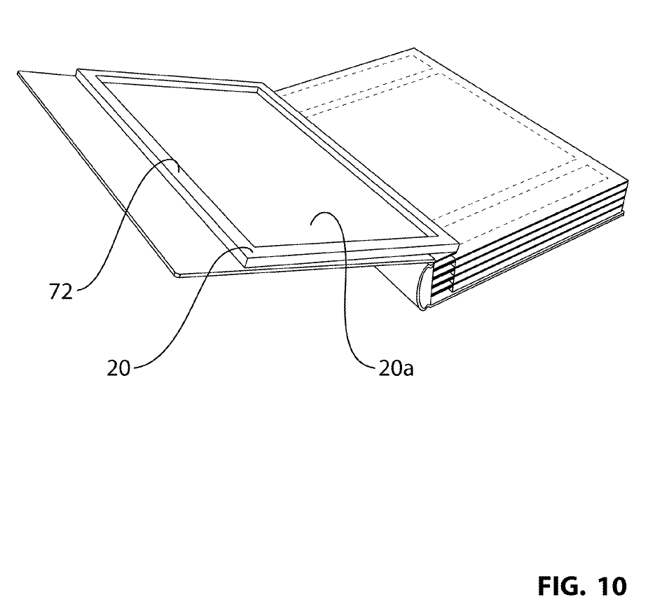

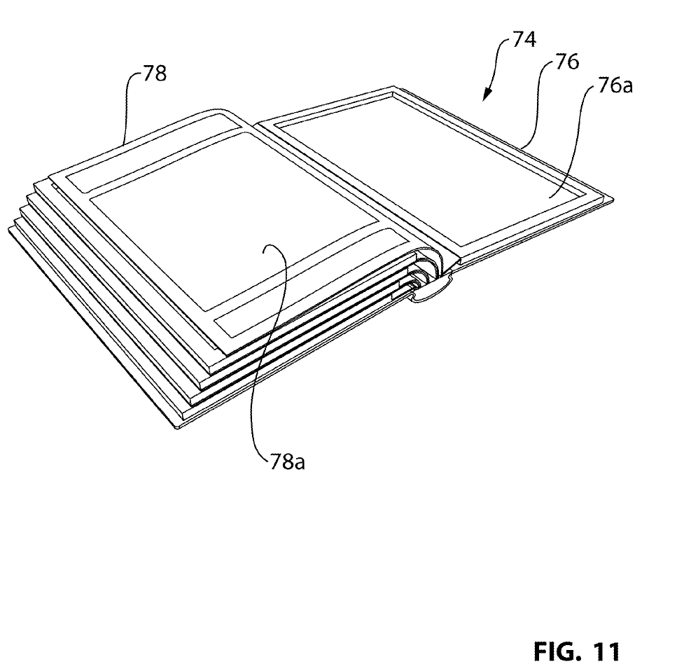

FIG. 10 shows a variation of the first left hand page panel face 20 in which the first memorabilia receiving region 20a occupies substantially the entire first left hand page panel face, but for a frame boundary region shown at 72. FIG. 11 shows another variation in which a relatively thick panel 74 presents a right hand page panel face 76 which is provided with a memorabilia receiving region 76a and a neighboring relatively thin page panel 78 with indicia 78a representative of graphics and/or text descriptive of the corresponding event or circumstance associated with a memorabilia item to be located in the memorabilia receiving region 76a.

Thus, the book 10 provides a means of presenting a group of associated or linked memorabilia items using the natural function of enjoying leafing through a book. The reader in this example thus sees two facing pages, though the benefit may also be given with one or three or more pages if desired. Considering a sports example, at the top of one page there may be provided a picture of a sports personality, perhaps in an action stance with text. At the bottom there may be provided some text about the career of the personality. In this case, the opposite page may then include a large photo of the sports personality executing a famous game play, such as hitting a famous grand slam homer in baseball. On that same page, there is a location such as a die-cut opening. The die-cut opening may or may not migrate into or otherwise be part of the picture. Appearing through that die cut opening is a portion of an actual baseball jersey once worn by the personality or a chunk or section of the bat with which he hit his most famous homer or even a piece of the leather from the ball he hit out of the park.

In this example, the book 10 combines text, photos and memorabilia in a matter that enhances each of the text, photos and memorabilia more than the text or photos or memorabilia presented separately.

In another example, the book 10 may provide a memorabilia article within a graphically framed region. This example may provide, then, a book with a plurality of sheets, each with a facing page, the facing pages organized in left-right pairs wherein text and/or graphics is located on one page and the memorabilia article is located on the other page. In this example, each left-right pair relate to one of a series/pattern of memorable events/people and each left-right pair in the series/pattern have a common historical/sports theme, such as a sports theme, a historical or geographical theme, a genealogical them, an educational theme, an entertainment theme, or one or more there of in a combination, or the like. The book may be particularly useful in which the memorabilia item presented is itself a fragment of a memorabilia article (and not, in this example, the whole memorabilia article), thereby enabling many subscribers to enjoy and cherish the event since each subscriber or each of a subgroups of subscribers get a fragment of the item itself. Moreover, the memorabilia item in this particular example is one which is considerably larger in at least one dimension than the book presenting it, thereby making the fragment a useful means of presenting the memorabilia article along with other indicia to provide additional perspective to the viewer. For instance, the fragment may be significantly larger than one or more than one dimension of the book, such as its width, length or thickness, such as at least 1.5 times larger, or at least 2 times larger. Alternatively, the fragment may be significantly larger than one or more than one dimension of the page associated with it, such as the width of the page or its or thickness, such as at least 1.5 times larger, or at least 2 times larger. In addition, a table of contents/index sheet identifies at least one facing page of each left-right pair.

If desired, the book 10 may be provided without the index page as desired.

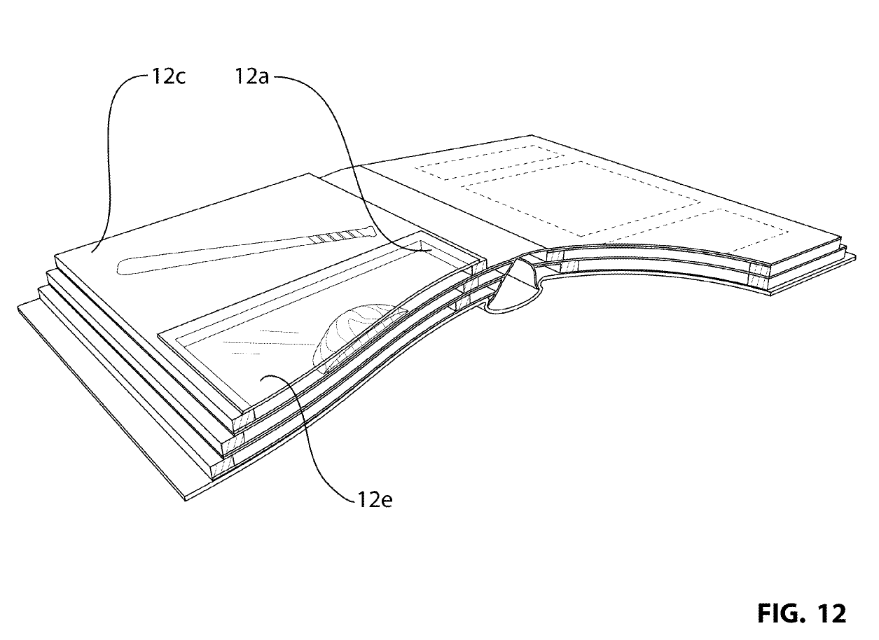

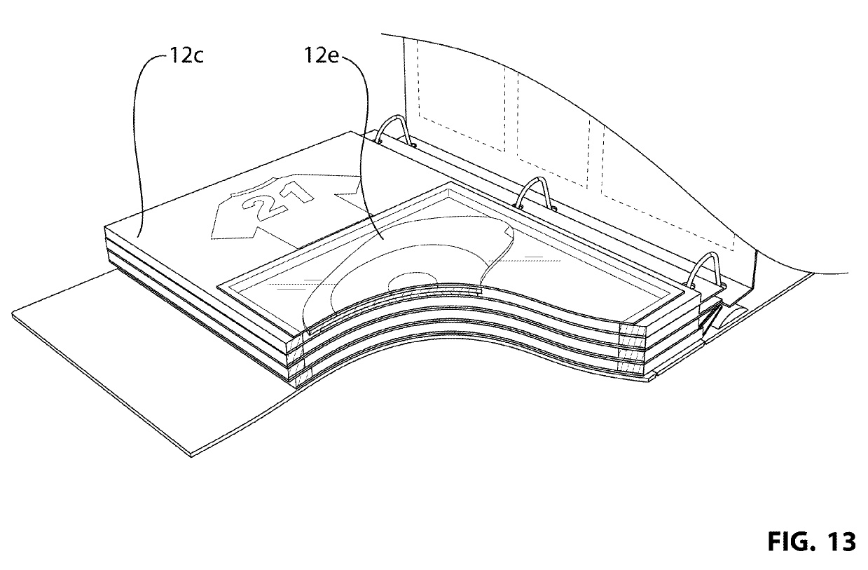

FIG. 12 shows another variation of the book 10 in which one of the second panels 12c is provided with a protective cover plate 12e to provide further protection for the memorabilia item. While the protective cover plate 12e is shown to cover just the region beyond the window opening 12a, it may cover the entire second panel 12c, as desired. The protective cover plate 12e may also be provided on the second panel 12c of each page panel 12 of the book in which a memorabilia item is presented, as desired. FIG. 13 presents a similar cover plate 12e on one of the second panels 12c of the book as shown in FIG. 5.

While the examples of the book 10 shown and described present page panel faces in left-to-fright orientation, they may, if desired, be presented in other arrangements, such as in an upper to lower format. This would be the case if the book 10 in FIG. 3 is arranged so that the inclined axis shown at 79 in FIG. 3 becomes a vertical axis.

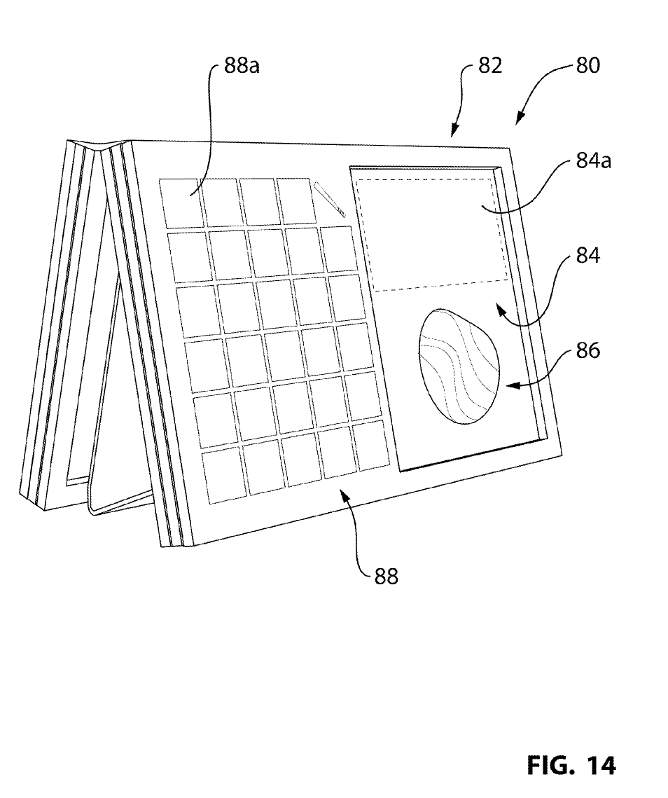

Still another variation is shown in FIG. 14, in which a book 80 presents a singular panel face 82 having a window 84 presenting a memorabilia item 86 and an adjacent region 88 providing graphics and/or text 88a. If desired, graphics and/or text may also be provided in the window 84, as shown at 84a.

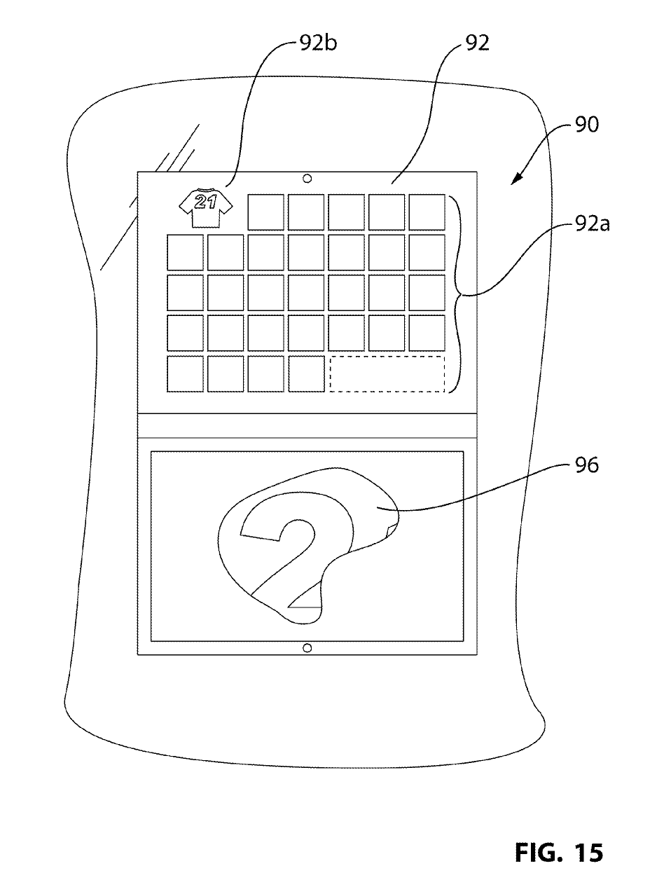

Still another variation is shown in FIG. 15, in which a book 90 is provided in the form of a vertically oriented calendar with an upper panel face 92 providing indicia representative of graphics and/or text which in this case includes a monthly calendar layout 92a with an image of a jersey 92b. A lower panel face 94 includes a window 94a presenting a memorabilia item 96, in this case a segment of the jersey shown at 92b.

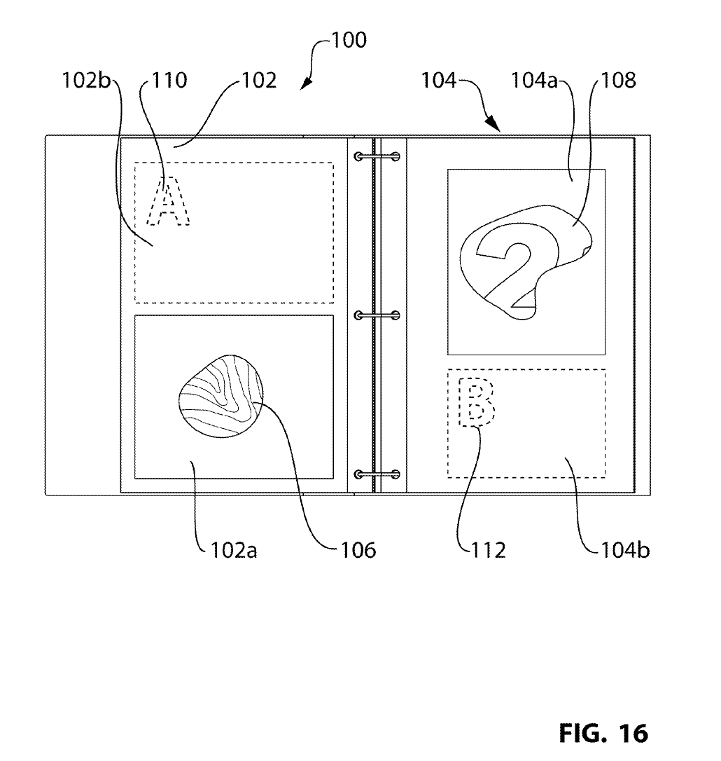

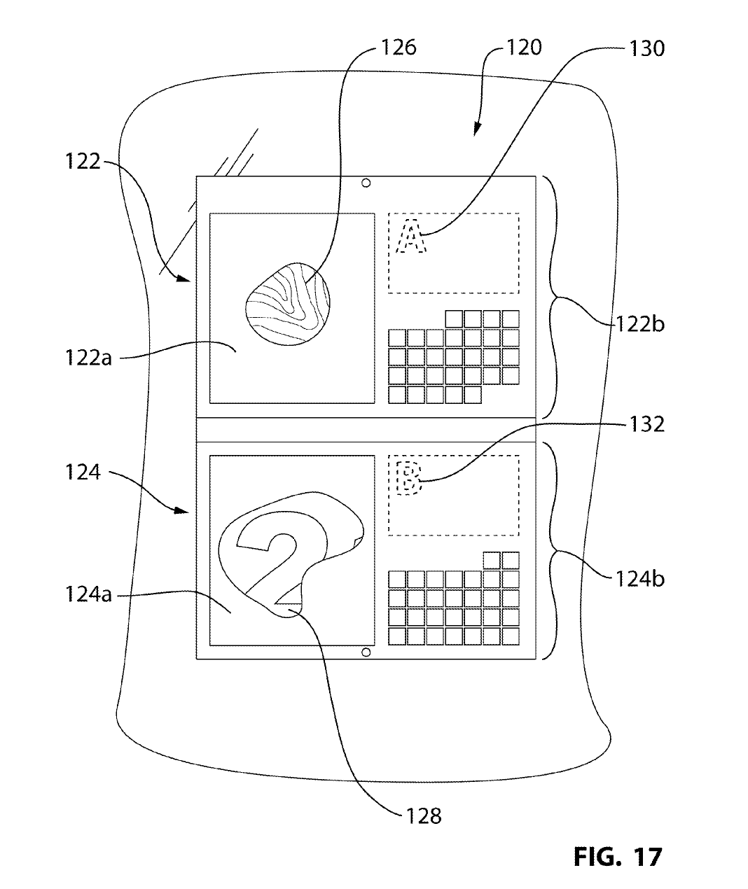

Still another variation is shown in FIG. 16, in which a book 100 presents a pair of adjacent left and right panel faces 102, 104, each having window presenting a memorabilia item 106,108 and an adjacent region 102b, 104b providing graphics and/or text 110, 112. Similarly, FIG. 17 presents a book 120 in a calendar format with a pair of adjacent upper and lower panel faces 122, 124, each having window 122a, 124a presenting a memorabilia item 126, 128 and an adjacent region 122b, 124b, providing graphics and/or text 130, 132.

Thus, while the book 10 is shown and described as such above in both bound and unbound form, it may be presented as a booklet, a leaflet or the like.

While the present invention has been described for what are presently considered the preferred embodiments, the invention is not so limited. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. A book for presenting a group of memorabilia items relating to a series of linked events and/or circumstances, comprising:
a plurality of page panels, the page panels providing a number of page panel faces organized in pairs, each pair presenting a left hand page panel face and a right hand page panel face;
a first of the pairs relating to a first event and/or circumstance, the first pair including a first right hand page panel face and a first left hand page panel face, either one or both including indicia representative of graphics and/or text descriptive of the first event or circumstance and the other including a first memorabilia receiving region to receive a first memorabilia item pertinent to the first event and/or circumstance; and
the first memorabilia item positioned in the first memorabilia receiving region;
a second of the pairs relating to a second event and/or circumstance which is linked with the first event and/or circumstance by a predetermined value, the second pair including a second right hand page panel face and a second left hand page panel face, either one or both including indicia representative of graphics and/or text descriptive of the second event and/or circumstance and the other including a second memorabilia receiving region to receive a second memorabilia item pertinent to the second event and/or circumstance; and
the second memorabilia item positioned in the second memorabilia receiving region.

2. A book as defined in claim 1, wherein the first right hand page panel face and the second left hand page panel face are located on opposite sides of a single page panel.

3. A book as defined in claim 1, further comprising a binder portion, the plurality of page panels being removably bound with the binder portion.

4. A book as defined in claim 3, the binder portion including a plurality of ring portions, each movable between a substantially continuous closed position and an open position.

5. A book as defined in claim 1, wherein the number of page panel faces includes a third pair having a third right hand page panel face and a third left hand page panel face, either one or both including indicia representative of graphics and/or text descriptive of a third event and/or circumstance and the other including a third memorabilia receiving region to receive a third memorabilia item pertinent to the third event and/or circumstance; the third right hand page panel face being provided on a first intermediate page panel, the first intermediate page panel including an index left hand page panel face including indicia representative of graphics and/or text descriptive of a first version of an index for the book.

6. A book as defined in claim 5, further comprising a pair of second intermediate page panels to replace the first intermediate page panel and to provide the third right hand page panel face and to provide a fourth pair of page panel faces for a fourth event and/or circumstance, either one of the fourth page panel faces including indicia representative of graphics and/or text descriptive of the fourth event and/or circumstance and the other including a fourth memorabilia receiving region to receive a fourth memorabilia item pertinent to the fourth event and/or circumstance, one of the second intermediate page panels including an index page panel face whose indicia are representative of graphics and/or text descriptive of a second version of the index for the book and including the fourth event and/or circumstance.

7. A book as defined in claim 6, the event and/or circumstance is a sports event and/or circumstance being selected from professional and/or non-professional sports events or circumstances.

8. A book as defined in claim 7, the sports events and/or circumstances including one or games, events, circumstances or matches in one or more seasons and/or for one or more teams and/or for one or more athletes.

9. A book as defined in claim 8, the sports events and/or circumstances including one or more games of hockey, baseball, basketball, football, automobile racing and/or soccer.

10. A book as defined in claim 9, wherein the sports events and/or circumstances include one or more Olympic games or events and/or circumstances.

11. A book as defined in claim 7, the first and/or second memorabilia item including a portion of a game element, an item of game equipment, a race car or race vehicle or a portion of an item related directly or indirectly with a game element, an item of game equipment, a race car or race vehicle, or a personal article of, or an article related directly or indirectly to, a celebrated individual associated with the corresponding sports event and/or circumstance.

12. A book as defined in claim 11, wherein the indicia is representative of biographical information relating to the celebrated individual.

13. A book as defined in claim 11, wherein the indicia is representative of an image of the celebrated individual.

14. A method of selling a memorabilia book presenting a group of memorabilia items relating to a series of linked events and/or circumstances, comprising:
providing a binder portion and a plurality of page panels to be removably mounted in the binder portion;
providing on the plurality of page panels, a number of page panel faces organized in pairs, each pair presenting a left hand page panel face and a right hand page panel face;
configuring a first of the pairs to relate to a first event and/or circumstance, with the first pair including a first right hand page panel face and a first left hand page panel face, with either one including indicia representative of graphics and/or text descriptive of the first event and/or circumstance and the other including a first memorabilia receiving region to receive a first memorabilia item pertinent to the first event and/or circumstance; and
locating the first memorabilia item in the first memorabilia receiving region;
configuring a second of the pairs to relate to a second event and/or circumstance which is associated with the first event and/or circumstance by a predetermined correspondence, with the second pair including a second right hand page panel face and a second left hand page panel face, with either one including indicia representative of graphics and/or text descriptive of the second event and/or circumstance and the other including a second memorabilia receiving region to receive a second memorabilia item pertinent to the second event and/or circumstance; and
locating the second memorabilia item in the second memorabilia receiving region;
assembling sale packages including one or more binder portions and a set of page panels for each binder portion;
collecting one or more orders for sale packages from one or more buyers;
accepting one or more payments for the sale packages from the one or more buyers; and
dispatching the sale packages to the one or more buyers.

15. A method as defined in claim 14, further comprising providing the first right hand page panel face and the second left hand page panel face on opposite sides of a single page panel.

16. A method as defined in claim 14, further comprising providing the binder portion with a plurality of ring portions, configuring the rings to be movable between a substantially continuous closed position and an open position to extend through corresponding openings in the page panels.

17. A method as defined in claim 14, further comprising:
providing the number of page panel faces with a third pair including a third right hand page panel face and a third left hand page panel face, with either one including indicia representative of graphics and/or text descriptive of a third event and/or circumstance and the other including a third memorabilia receiving region to receive a third memorabilia item pertinent to the third event and/or circumstance;
locating the third memorabilia item in the third memorabilia receiving region;
providing the third right hand page panel face on a first intermediate page panel;
providing the first intermediate page panel with an index left hand page panel face including indicia representative of graphics and/or text descriptive of a first version of an index for the book.

18. A method as defined in claim 17, further comprising offering the one or more buyers a subscription program to update the book.

19. A method as defined in claim 17, further comprising providing a pair of second intermediate page panels to replace the first intermediate page panel and to provide a fourth pair of page panel faces for a fourth event and/or circumstance, with either one of the fourth page panel faces including indicia representative of graphics and/or text descriptive of the fourth event and/or circumstance and the other including a fourth memorabilia receiving region to receive a fourth memorabilia item pertinent to the fourth event and/or circumstance, one of the second intermediate page panels including a left hand index page panel face whose indicia is representative of graphics and/or text descriptive of a second version of the index for the book and including the fourth event and/or circumstance.

20. A method as defined in claim 19, comprising:
offering a subscription program to the one or more buyers;
assembling subscription program packages including one or more sets of second intermediate page panels;
collecting one or more orders for subscription program packages for one or more buyers;
accepting one or more payments for the subscription program packages from the one or more buyers; and
dispatching the subscription program packages to the one or more buyers.

21-28. (canceled)
